(19) United States
(12) Patent Application Publication
(10) Pub. No.: US 2019/0375668 A1
(43) Pub. Date: Dec. 12, 2019

(54) GLASS ARTICLE WITH REDUCED THICKNESS VARIATION, METHOD FOR MAKING AND APPARATUS THEREFOR

(71) Applicant: CORNING INCORPORATED, Corning, NY (US)

(72) Inventors: Andrea Weiss BOOKBINDER, Corning, NY (US); Bradley Frederick BOWDEN, Corning, NY (US); Ronald Lee KIMBALL, Corning, NY (US); Steven Howard TARCZA, Painted Post, NY (US); William Anthony WHEDON, Corning, NY (US)

(73) Assignee: Corning Incorporated, Corning, NY (US)

(21) Appl. No.: 16/489,458

(22) PCT Filed: Feb. 23, 2018
(86) PCT No.: PCT/US2018/019391

§ 371 Date: Aug. 28, 2019

Related U.S. Application Data
(60) Provisional application No. 62/464,722, filed on Feb. 28, 2017.

(51) Int. Cl. C03B 17/06; C03C 3/078; C03C 3/083; C03C 3/087

(52) U.S. Cl. CPC C03B 17/064; C03C 3/087; C03C 3/083; C03C 3/078

(57) ABSTRACT

A glass article with a length equal to or greater than about 880 mm, a width orthogonal to the length equal to or greater than about 680 mm and a thickness T defined between first and second major surfaces is described. A total thickness variation TTV across the width of the glass article equal to or less than about 4 m. A maximum sliding interval range MSIR obtained from a predetermined interval moved in 5 mm increments across a width of the glass article is equal to or less than about 4 m. A method of making the glass article, and an apparatus therefor are also disclosed.

### CROSS-REFERENCE TO RELATED APPLICATIONS

This application claims the benefit of priority under 35 U.S.C. § 119(e) of U.S. Provisional Application Ser. No. 62/464,722 filed on Feb. 28, 2017.

### BACKGROUND

### Field

The present disclosure relates generally to an apparatus for forming a glass article, such as a glass sheet, and in particular for minimizing thickness variations across a width of the glass article.

### Technical Background

The manufacture of optical quality glass articles, such as glass sheets used in a variety of applications, including lighting panels, or liquid crystal or other forms of visual displays, typically involves drawing molten glass in ribbon form. The ribbon may be separated into singular glass sheets, or in some instances wound in long lengths on a suitable spool. Advances in display technology continue to increase pixel density, and thereby the resolution, of display panels. Accordingly, requirements on the glass sheets incorporated into such panels are expected to increase. For example, thickness deviation limits needed to facilitate TFT deposition processes are expected to be further reduced. To meet this challenge, a precise temperature field must be maintained across the ribbon as the ribbon is drawn from the forming body.

### SUMMARY

In accordance with the present disclosure, a glass article is described comprising a length equal to or greater than about 880 millimeters, a width orthogonal to the length and equal to or greater than about 680 millimeters, a first major surface, a second major surface opposing the first major surface, a thickness T defined between the first and second major surfaces, and wherein a total thickness variation TTV across the width of the glass article equal to or less than about 4 μm.

In some embodiments, TTV is equal to or less than about 2 μm. In still other embodiments, TTV is equal to or less than about 1 μm. In still further embodiments, TTV is equal to or less than about 0.25 μm. In various embodiments, the first and second major surfaces are unpolished.

In some embodiments, an average surface roughness Ra of the first and second major surfaces is equal to or less than about 0.25 nm.

In some embodiments, a maximum sliding interval range MSIR obtained from a predetermined interval moved in 5 millimeter increments across a width of the glass article is equal to or less than about 4 μm

In some embodiments, the predetermined interval is in a range from about 25 mm to about 750 mm, for example in a range from about 25 mm to about 100 mm, such as in a range from about 25 mm to about 75 mm.

In some embodiments, the width is equal to or greater than about 3100 mm. The length can be equal to or greater than about 3600 mm.

In some embodiments, the glass is a substantially alkali free glass, comprising in mole percent:

| | |
|---|---|
| SiO₂ | 60-80 |
| Al₂O₃ | 5-20 |
| B₂O₃ | 0-10 |
| MgO | 0-20 |
| CaO | 0-20 |
| SrO | 0-20 |
| BaO | 0-20 |
| ZnO | 0-20. |

In some embodiments, the glass is a substantially alkali free glass, comprising in mole percent:

| | |
|---|---|
| SiO₂ | 64.0-71.0 |
| Al₂O₃ | 9.0-12.0 |
| B₂O₃ | 7.0-12.0 |
| MgO | 1.0-3.0 |
| CaO | 6.0-11.5 |
| SrO | 0-2.0 |
| BaO | 0-0.1, |

where 1.00≤Σ[RO]/[Al₂O₃]≤1.25, [Al₂O₃] is the mole percent of Al₂O₃ and Σ[RO] equals the sum of the mole percents of MgO, CaO, SrO, and BaO.

In another embodiment, a glass article is described, comprising a length equal to or greater than about 880 millimeters, a width orthogonal to the length and equal to or greater than about 680 millimeters, a first major surface, a second major surface opposite the first major surface, a thickness T defined between the first and second major surfaces, and wherein a maximum sliding interval range MSIR obtained from a sliding interval equal to or less than about 750 mm moved in 5 millimeter increments across a width of the glass article is equal to or less than about 8 μm.

In some embodiments, the MSIR is equal to or less than about 6.5 μm for a sliding interval equal to or less than about 400 mm.

In some embodiments, the MSIR is equal to or less than about 6 μm for a sliding interval equal to or less than about 330 mm

In still other embodiments, the MSIR is equal to or less than about 4.5 μm for a sliding interval equal to or less than about 150 mm.

In other embodiments, the MSIR is equal to or less than about 4 μm for a sliding interval equal to or less than about 100 mm.

In various embodiments, the MSIR is equal to or less than about 2 μm for a sliding interval equal to or less than about 25 mm.

In some embodiments, the first and second major surfaces are unpolished.

In various embodiments, an average surface roughness Ra of the first and second major surfaces is equal to or less than about 0.25 nm.

In various embodiments, the width is equal to or greater than about 3100 mm. In some embodiments, the length is equal to or greater than about 3600 mm.

In still another embodiment, a glass article is described, comprising a length equal to or greater than about 880 millimeters, a width orthogonal to the length and equal to or greater than about 680 millimeters, a first major surface, a second major surface opposing the first major surface, a thickness T defined between the first and second major surfaces, and a total thickness variation TTV across the width of the glass article is equal to or less than about 4 μm and a maximum sliding interval range MSIR obtained from a predetermined interval moved in 5 millimeter increments across a width of the glass article is equal to or less than about 4 μm.

In some embodiments, TTV is equal to or less than about 2 μm, for example equal to or less than about 1 μm, such as equal to or less than about 0.25 μm.

In some embodiments, the first and second major surfaces are unpolished. In some embodiments, an average surface roughness Ra of the unpolished first and second major surfaces is equal to or less than about 0.25 nm.

In some embodiments, the predetermined interval is in a range from about 25 mm to about 750 mm.

In some embodiments, the predetermined interval is in a range from about 25 mm to about 100 mm, for example in a range from about 25 mm to about 75 mm.

In yet another embodiment, a glass platter blank is described, comprising a first major surface, a second major surface opposite the first major surface, a thickness T defined between the first and second major surfaces, and a total thickness variation TTV across a diameter of the glass platter blank is equal to or less than about 2 μm, for example equal to or less than about 1 μm.

In some embodiments, a maximum sliding interval range MSIR obtained from a 25 mm interval moved in 5 millimeter increments across a diameter of the glass the glass platter blank is equal to or less than about 2 μm.

An average surface roughness Ra of one or both of the first and second major surfaces of the glass platter blank can be equal to or less than about 0.50 nm, for example equal to or less than about 0.25 nm.

In another embodiment, a method of making a glass article is described, comprising drawing a glass ribbon from a forming body in a draw direction, the glass ribbon comprising opposing edge portions and a central portion positioned between the opposing edge portions, the glass ribbon comprising a viscous zone and an elastic zone, forming in the viscous zone of the glass ribbon a thickness perturbation in the central portion comprising a characteristic width equal to or less than about 225 mm in a width direction of the glass ribbon orthogonal to the draw direction, and a maximum sliding interval range from a 100 mm sliding interval moved in 5 mm increments across a width of the central portion in the elastic zone is equal to or less than about 0.0025 mm.

In some embodiments, the characteristic width is equal to or less than about 175 mm and the maximum sliding interval range is equal to or less than about 0.0020 mm.

In some embodiments, the characteristic width is equal to or less than about 125 mm and the maximum sliding interval range is equal to or less than about 0.0015 mm.

In some embodiments, the characteristic width is equal to or less than about 75 mm and the maximum sliding interval range is equal to or less than about 0.0006 mm.

In still other embodiments, the characteristic width is equal to or less than about 65 mm and the maximum sliding interval range is equal to or less than about 0.0003 mm.

In various embodiments, the perturbation may formed by cooling the glass ribbon, although in further embodiments, the perturbation may be formed by heating the glass ribbon, for example using one or more laser beams impinging on the glass ribbon.

In some embodiments, a distance between a bottom edge of the forming body and a thickness maximum of the thickness perturbation is equal to or less than about 8.5 cm, while in other embodiments, the distance between the bottom edge of the forming body and the thickness maximum of the thickness perturbation can be equal to or less than about 3.6 cm.

In various embodiments, a total thickness variation of the central portion in the elastic zone in a width direction orthogonal to the draw direction is equal to or less than about 4 μm, for example equal to or less than about 2 μm, such as equal to or less than about 1 μm.

In yet another embodiment, a method of making a glass article is disclosed, comprising flowing molten glass into a trough of a forming body, the molten glass overflowing the trough and descending along opposing forming surfaces of the forming body as separate flows of molten glass that join below a bottom edge of the forming body, drawing a ribbon of the molten glass from the bottom edge in a draw direction, and cooling the ribbon with a cooling apparatus comprising a thermal plate extending in a width direction of the glass ribbon orthogonal to the draw direction, the cooling apparatus further comprising a plurality of cooling tubes positioned within the cooling apparatus, each cooling tube of the plurality of cooling tubes comprising a first tube with a closed end adjacent the thermal plate and a second tube extending into the first tube with an open end spaced apart from the closed end of the first tube, the cooling comprising flowing a cooling fluid into the second tubes of the plurality of cooling tubes, the cooling further comprising forming a plurality of thickness perturbations on the ribbon corresponding to a location of each cooling tube, each thickness perturbation comprising a characteristic width equal to or less than about 225 mm.

In some embodiments, the characteristic width is equal to or less than about 175 mm, for example equal to or less than about 125 mm, equal to or less than about 75 mm or equal to or less than about 65 mm.

Each cooling tube of the plurality of cooling tubes may be in contact with the thermal plate.

In yet another embodiment, an apparatus for making a glass ribbon is disclosed, comprising a forming body comprising a trough configured to receive a flow of molten glass and converging forming surfaces that join along a bottom edge of the forming body from which a glass ribbon is drawn in a draw direction along a vertical draw plane, a cooling apparatus comprising a thermal plate extending in a width direction of the flow of molten glass and a plurality of cooling tubes positioned within the cooling apparatus, each cooling tube of the plurality of cooling tubes comprising a first tube with a closed end adjacent the thermal plate and a second tube extending into the first tube with an open end adjacent the closed end of the first tube.

In some embodiments, each first tube of the plurality of cooling tubes is in contact with the thermal plate.

In some embodiments, a longitudinal axis of each first tube intersects the draw plane a distance from the bottom edge equal to or less than about 8.5 cm, for example equal to or less than about 3.6 cm.

In some embodiments, a distance between the draw plane and the thermal plate is equal to or less than about 9 cm, for example equal to or less than about 1.5 cm.

In still another embodiment, an apparatus for making a glass ribbon is described, comprising, a forming body comprising a trough configured to receive a flow of molten glass and converging forming surfaces that join along a bottom edge of the forming body from which a glass ribbon is drawn in a draw direction along a vertical draw plane, a cooling apparatus positioned below the bottom edge comprising a metal plate extending in a width direction of the flow of molten glass, the metal plate comprising a plurality of passages formed within the metal plate, each passage of the plurality of passages comprising a closed distal end and an open proximal end, and a cooling tube extending through the open proximal end such that an open distal end of the cooling tube is adjacent to and spaced apart from the distal end of the passage.

In some embodiments, the distance between the draw plane and the thermal plate is equal to or less than about 10 cm, for example equal to or less than about 5 cm, such as equal to or less than about 3 cm. In some embodiments, the distance between the draw plane and the thermal plate is equal to or less than about 1.5 cm, although other distances are contemplated based on the location of the cooling apparatus below the bottom edge of the forming body.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

FIG. 1 is a perspective view of a glass article, in the form of a glass sheet, in accordance with embodiments of the present disclosure;

FIG. 2 is an edge view of an exemplary glass sheet exhibiting thickness deviations, and illustrating measurement of total thickness variation (TTV);

FIG. 3 is an edge view of an exemplary glass sheet exhibiting thickness deviations, and illustrating measurement of maximum sliding interval range (MSIR)

FIG. 4 is a perspective view of a HDD platter blank according to embodiments of the present disclosure;

FIG. 5 is a schematic view of an exemplary glass making apparatus;

FIG. 6 is a schematic view of a portion of the glass making apparatus of FIG. 5;

FIG. 7 is a close-up view of a portion of the apparatus of FIG. 6 according to various embodiments of the present disclosure;

FIG. 8 is a close-up view of a portion of the apparatus of FIG. 6 according to other embodiments of the present disclosure;

FIG. 9A is a cross sectional view of an embodiment of a slide gate shown in FIG. 6, as seen from the top;

FIG. 9B is a cross sectional view of a slide gate embodiment shown in FIG. 9, as seen from an end;

FIG. 10 is a cross sectional view of another embodiment of a slide gate, as seen from the top

FIG. 11 is a partial cross sectional view of another embodiment of a slide gate, as seen from the top;

FIG. 12 is a partial cross sectional view of still another embodiment of a slide gate, as seen from the top;

FIG. 13 is a partial cross sectional view of yet another embodiment of a slide gate, as seen from the top;

FIG. 14 is a plot of actual thickness as a function of position across the width of a ribbon drawn using the glass making apparatus of FIG. 5, without an actively cooled slide gate, compared to modeled thickness with an actively cooled slide gate;

FIG. 15 is a plot of the difference between actual and modeled thickness difference of FIG. 14;

FIG. 16 is a plot of measured thickness as a function of position across the width of a ribbon drawn using the glass making apparatus of FIG. 5, without an actively cooled slide gate, compared to modeled thickness with an actively cooled slide gate, and further including ΔTmax for a 25 mm sliding interval for each of the measured data and the modeled data;

FIG. 17 is a plot of ΔTmax for a 100 mm sliding interval for each of the measured data and the modeled data of FIG. 16;

FIG. 18 is a plot of the modeled amplitude of a thickness perturbation as a function of distance below the bottom edge (root) of ribbon drawn from an exemplary forming body for three different slide gate positions (distance from the ribbon);

FIG. 19 is a plot of modeled thickness change as a function of distance across a width of a ribbon drawn from an exemplary forming body relative to a centerline of the ribbon, for the four slide gate positions of FIG. 18;

FIG. 20 is a plot of modeled thickness change as a function of distance across a width of the ribbon drawn from an exemplary forming body relative to a centerline of the ribbon, for one of the four slide gate positions of FIG. 18, the figure also showing a plot of temperature variation associated with the thickness change;

FIG. 21 is a plot of modeled thickness change as a function of distance across a width of the ribbon drawn from an exemplary forming body relative to a centerline of the ribbon, for another of the four slide gate positions of FIG. 18, the figure also showing a plot of temperature variation associated with the thickness change;

FIG. 22 is a plot of the modeled 100 mm MSIR as a function of the FWHM (characteristic width) of the thickness perturbation of a ribbon drawn from an exemplary forming body.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, total thickness variation (TTV) refers to the difference between the maximum thickness and the minimum thickness of a glass sheet across a defined interval υ, typically an entire width of the glass sheet.

As used herein, maximum sliding interval range (MSIR) refers to the difference between a maximum thickness and a minimum thickness of a glass substrate across a plurality of defined intervals. MSIR is obtained as the maximum thickness difference of a plurality of maximum thickness differences, the plurality of maximum thickness differences obtained from a target interval κ moved across a predetermined dimension of a glass sheet in predetermined increments of length 8, n times, each iteration of the target interval resulting in a maximum thickness difference ΔTmax. Each target interval κₙ includes a maximum thickness Tmaxₙ and a minimum thickness Tminₙ, and a maximum thickness difference defined as ΔTmaxₙ=Tmaxₙ−Tminₙ. The foregoing process leads to n ΔTmaxₙ's, and the maximum thickness difference of the n ΔTmax's is the maximum sliding interval range, MSIR. It should be noted that as the interval κ becomes equal to the interval υ, the MSIR is equal to TTV.

As used herein, the full width at half maximum (FWHM) of a portion of a curve is the width of the portion measured between those points on the y-axis which are half the maximum amplitude, and will be referred to synonymously as the characteristic width of the curve. FWHM can be used, for example, to describe the width of a bump on a curve or function.

As display resolution has increased, so too have the demands on thickness uniformity of the glass substrates comprising the display panels. A typical LCD display panel includes a backplane glass substrate on which a pattern of thin film transistors TFTs are deposited, for example by photolithography, that control the polarization state of the liquid crystal material contained in a volume between the backplane substrate and a cover or sealing substrate sealed thereto, and which TFT's help define individual pixels of the display. Such thin film deposition processes rely on a flat substrate to accommodate the limited focal depth of the photolithography process.

In other instances, annular glass disks may be used as hard disk drive (HDD) platters. Because the read and/or write heads on the pickup arms travel mere nanometers above the platter surface, the platter must be exceptionally flat. These annular glass disks may be cut from large glass sheets in multiples, and significant manufacturing costs can be realized if the need for grinding and/or polishing of the major surfaces of the large glass sheet, or alternatively the individual annular disks cut therefrom, can be eliminated. Accordingly, a glass sheet exhibiting reduced thickness variation, and a manufacturing method capable of producing such large glass sheets with exceptional flatness without the need for post-forming surface grinding and/or polishing, would be useful.

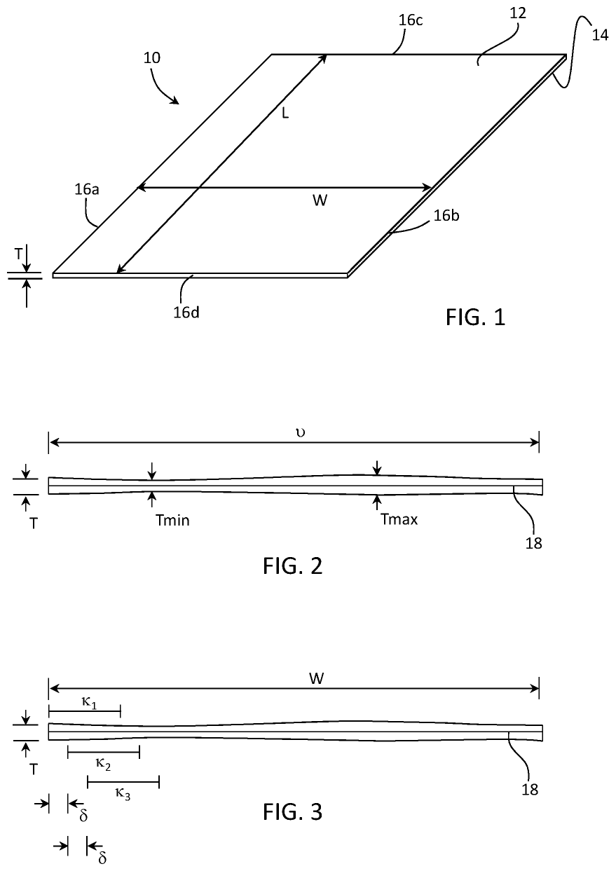

FIG. 1 is a schematic view of a glass article, for example a glass sheet 10, comprising a first major surface 12, an opposing second major surface 14, and a thickness T orthogonal to the first and second major surfaces defined therebetween. While glass sheet 10 may be any shape suitable for a particular application, for ease of description, unless otherwise indicated, it will be assumed hereinafter that glass sheet 10 comprises a rectangular shape bounded by a first pair of opposing edges 16a and 16b and a second pair of opposing edges 16c and 16d, wherein edges 16a, 16b are orthogonal to edges 16c and 16d. Accordingly glass sheets described herein can comprise a width W and a length L orthogonal to width W, wherein the width and length are each parallel with a respective pair of opposing edges. While orientation of width and length can be selected arbitrarily, for convenience, width W will be denoted herein as the shorter of the two dimensions and conversely, length L will be denoted as the longer of the two dimensions. Thus, glass sheets described herein may have a width equal to or greater than about 680 mm, for example equal to or greater than about 1000 mm, equal to or greater than about 1300 mm, equal to or greater than about 1500 mm, equal to or greater than about 1870 mm, equal to or greater than about 2120 mm, equal to or greater than about 2300 mm, equal to or greater than about 2600 mm, or equal to or greater than about 3100 mm. Respective lengths can be equal to or greater than about 880 mm, equal to or greater than about 1200 mm, equal to or greater than about 1500 mm, equal to or greater than about 1800 mm, equal to or greater than about 2200 mm, equal to or greater than about 2320 mm, equal to or greater than about 2600 mm, or equal to or greater than about 3600 mm. For example, glass sheets described herein may have dimensions expressed as W×L equal to or greater than about 680 mm×880 mm, equal to or greater than about 1000 mm×1200 mm, equal to or greater than about 1300 mm×1500 mm, equal to or greater than about 1500 mm×1800 mm, equal to or greater than about 1870×2200 mm, equal to or greater than about 2120 mm×2320 mm, equal to or greater than about 2300 mm×2600 mm, equal to or greater than about 2600 mm×3000 mm, or equal to or greater than about 3100 mm×3600 mm.

The first and/or second major surfaces can have an average roughness Ra equal to or less than about 0.5 nm, equal to or less than about 0.4 nm, equal to or less than about 0.3 nm, equal to or less than about 0.2 nm, equal to or less than about 0.1 nm, or in a range from about 0.1 nm and about 0.6 nm. In some embodiments, a surface roughness of first and second major surfaces 12, 14 can be equal to or less than about 0.25 nm, as-drawn. By as-drawn, what is meant is the surface roughness of the glass article as the glass article is formed, without surface treatment, e.g., grinding or polishing of the surface. Surface roughness is measured by coherence scanning interferometry, confocal microscopy or other suitable methods.

Thickness T may be equal to or less than 4 mm, equal to or less than about 3 mm, equal to or less than about 2 mm, equal to or less than about 1.5 mm, equal to or less than about 1 mm, equal to or less than about 0.7 mm, equal to or less than about 0.5 mm, or equal to or less than about 0.3 mm. For example, in some embodiments, thickness T may be equal to or less than about 0.1 mm, such as in a range from about 0.05 mm to about 0.1 mm.

Glass articles described herein can exhibit a total thickness variation TTV equal to or less than about 4 μm, for example equal to or less than about 3 μm, equal to or less than about 2 μm, equal to or less than about 1 μm, equal to or less than about 0.5 μm or equal to or less than about 0.25 μm.

Glass articles described herein can exhibit a maximum sliding interval range, MSIR, equal to or less than about 2 μm for a sliding interval κ equal to or less than about 25 mm with an increment δ of 5 mm, equal to or less than about 4 μm for a sliding interval κ equal to or less than about 100 mm with an increment δ of 5 mm, equal to or less than about 4.5 μm for a sliding interval κ equal to or less than about 150 mm with an increment δ of 5 mm, equal to or less than about 6 μm for a sliding interval κ equal to or less than about 330 mm with an increment δ of 5 mm, equal to or less than about 6.5 μm for a sliding interval κ equal to or less than about 400 mm with an increment δ of 5 mm, or equal to or less than about 8.5 μm for a sliding interval κ equal to or less than about 750 mm with an increment δ of 5 mm.

Glass articles described herein may, in some embodiments, include two or more layers of glass. For example, various glass sheets may be formed by a fusion process and therefore include a fusion line 18 (see FIGS. 2, 3) visible from an edge of the glass article. The fusion line denotes an interface between layers of glass that were fused together during the manufacturing process. In some embodiments, the at least two layers of glass are the same chemical composition. However, in further embodiments, the layers may have different chemical compositions.

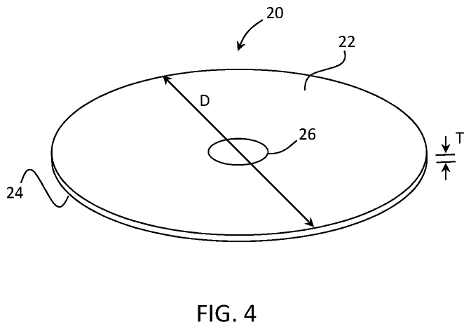

Referring now to FIG. 4, in some embodiments, the glass article can be glass disk, such as a preform (“blank”) for use as a HDD platter. As used herein “platter blank” shall be construed to mean a glass disk before deposition of magnetic medium onto a surface thereof and as-formed major surfaces. As shown in FIG. 4, platter blank 20 comprises a first as-formed major surface 22, a second as-formed major surface 24 and a thickness T defined therebetween. Edges of the platter blank may be finished (e.g., ground and/or polished). As used herein, the term as-formed means the major surfaces have not been subject to grinding and/or polishing, although in some embodiments, the major surfaces may have been chemically treated, for example in an ion exchange process. Platter blank 20 may have a diameter D equal to or less than about 100 mm, for example equal to or less than about 98 mm, for example equal to or less than about 96 mm, although in further embodiments, the platter blank can have a diameter greater than 100 mm. In some embodiments, platter blank 20 may be an annular disk with a central cut-out 26 concentric with an outer circumference of the platter blank. A surface roughness Ra of the platter blank is equal to or less than about 0.5 nm, for example equal to or less than about 0.25 nm. A TTV of the platter blank is equal to or less than about 4 μm, for example equal to or less than about 3 μm, such as equal to or less than about 2 μm or equal to or less than about 1 μm. An MSIR of the platter blank is equal to or less than about 2 μm for an interval of 25 mm moved across a major surface of the platter blank, for example across diameter D, in 5 mm increments. Platter blanks may be formed, for example, by cutting multiple platter blanks from a glass sheet, as described herein.

In some embodiments, glass articles described herein comprise an alkali-free glass with a high annealing point and high Young's modulus, allowing the glass to exhibit excellent dimensional stability (i.e., low compaction), for example during the manufacture of TFTs, thereby reducing variability during the TFT process. Glass with a high annealing point can help prevent panel distortion due to compaction (shrinkage) during thermal processing subsequent to manufacture of the glass. Additionally, some embodiments of the present disclosure can have high etch rates, allowing for the economical thinning of the backplane, as well as unusually high liquidus viscosities, thus reducing or eliminating the likelihood of devitrification on the relatively cold forming body.

In some embodiments, the glass may comprise an annealing point greater than about 785° C., 790° C., 795° C. or 800° C. Without being bound by any particular theory of operation, it is believed that such high annealing points result in low rates of relaxation—and hence comparatively small amounts of compaction.

In some embodiments, exemplary glasses can comprise a viscosity of about 35,000 poise (T₃₅ₖ) at a temperature equal to or less than about 1340° C., equal to or less than about 1335° C., equal to or less than about 1330° C., equal to or less than about 1325° C., equal to or less than about 1320° C., equal to or less than about 1315° C., equal to or less than about 1310° C., equal to or less than about 1300° C. or equal to or less than about 1290° C. In specific embodiments, the glass can comprise a viscosity of about 35,000 poise (T₃₅ₖ) at a temperature equal to or less than about about 1310° C. In other embodiments, the temperature of exemplary glasses at a viscosity of about 35,000 poise (T₃₅ₖ) is equal to or less than about 1340° C., equal to or less than about 1335° C., equal to or less than about 1330° C., equal to or less than about 1325° C., equal to or less than about 1320° C., equal to or less than about 1315° C., equal to or less than about 1310° C., equal to or less than about 1300° C. or equal to or less than about 1290° C. In various embodiments, the glass can comprise a T₃₅ₖ in the range of about 1275° C. to about 1340° C., or in the range of about 1280° C. to about 1315° C.

The liquidus temperature of a glass (T_{liq}) is the temperature above which no crystalline phases can coexist in equilibrium with the glass. In various embodiments, a T_{liq} of the glass used to form glass sheets described herein can be in a range of about 1180° C. to about 1290° C., or in a range of about 1190° C. to about 1280° C. In other embodiments, a viscosity corresponding to the liquidus temperature of the glass is greater than or equal to about 150,000 poise. In some embodiments, the viscosity corresponding to the liquidus temperature of the glass is greater than or equal to about 100,000 poise, equal to or greater than about 175,000 poise, equal to or greater than about 200,000 poise, equal to or greater than about 225,000 poise, or equal to or greater than about 250,000 poise.

In still other embodiments, exemplary glasses can comprise T₃₅ₖ−T_{liq}>0.25 T₃₅ₖ-225° C. This ensures a minimum tendency for the glass in a molten state to devitrify on the forming body of the fusion process.

Glasses described herein can comprise a strain point equal to or greater than about 650° C. A linear coefficient of thermal expansion (CTE) of various embodiments of the glasses over the temperature range 0-300° C. can satisfy the relationship 28×10⁻⁷/° C.≤CTE≤34×10⁻⁷/° C.

In one or more embodiments, the glass is a substantially alkali-free glass comprising in mole percent on an oxide basis:

| | |
|---|---|
| SiO₂ | 60-80 |
| Al₂O₃ | 5-20 |
| B₂O₃ | 0-10 |
| MgO | 0-20 |
| CaO | 0-20 |
| SrO | 0-20 |
| BaO | 0-20 |
| ZnO | 0-20 |

where Al₂O₃, MgO, CaO, SrO, BaO represent mole percents of the respective oxide components. As used herein, a “substantially alkali-free glass” is a glass with a total alkali concentration equal to less than about 0.1 mole percent, where the total alkali concentration is the sum of the Na₂O, K₂O, and Li₂O concentrations.

In some embodiments, the glass can be a substantially alkali-free glass comprising in mole percent on an oxide basis:

| | |
|---|---|
| SiO₂ | 65-75 |
| Al₂O₃ | 10-15 |
| B₂O₃ | 0-3.5 |
| MgO | 0-7.5 |
| CaO | 4-10 |
| SrO | 0-5 |
| BaO | 1-5 |
| ZnO | 0-5 |

wherein 1.0≤(MgO+CaO+SrO+BaO)/Al₂O₃<2 and 0<MgO/(MgO+Ca+SrO+BaO)<0.5.

In certain embodiments, the glass can be a substantially alkali-free glass comprising in mole percent on an oxide basis:

| | |
|---|---|
| SiO₂ | 67-72 |
| Al₂O₃ | 11-14 |
| B₂O₃ | 0-3 |
| MgO | 3-6 |
| CaO | 4-8 |
| SrO | 0-2 |
| BaO | 2-5 |
| ZnO | 0-1 |

### Wherein 1.0≤(MgO+CaO+SrO+BaO)/Al2O3<1.6 and 0.20<MgO/(MgO+Ca+SrO+BaO)<0.40.

In some embodiments, the glass can be a substantially alkali-free glass comprising in mole percent on an oxide basis:

| | |
|---|---|
| SiO₂ | 64.0-71.0 |
| Al₂O₃: | 9.0-12.0 |
| B₂O₃: | 7.0-12.0 |
| MgO: | 1.0-3.0 |
| CaO: | 6.0-11.5 |
| SrO: | 0-2.0 |
| BaO: | 0-0.1, |

wherein 1.00≤Σ[RO]/[Al₂O₃]≤1.25, and where [Al₂O₃] is the mole percent of Al₂O₃ and Σ[RO] equals the sum of the mole percents of MgO, CaO, SrO, and BaO.

In other embodiments, the glass can be a substantially alkali-free glass comprising in mole percent on an oxide basis:

| | |
|---|---|
| SiO₂ | 64.0-71.0 |
| Al₂O₃ | 9.0-12.0 |
| B₂O₃ | 7.0-12.0 |
| MgO | 1.0-3.0 |
| CaO | 6.0-11.5 |
| SrO | 0-1.0 |
| BaO | 0-0.1, |

wherein Σ[RO]/[Al₂O₃]≥1.00, and where [Al₂O₃] is the mole percent of Al₂O₃ and Σ[RO] equals the sum of the mole percents of MgO, CaO, SrO, and BaO.

Down draw sheet drawing processes and, in particular, fusion processes, can be used to produce glass articles as described herein. Without being bound by any particular theory of operation, it is believed a fusion process can produce glass substrates that do not require grinding and/or polishing of the major surfaces of the glass article prior to their use in subsequent manufacturing processes. For example, current glass substrate polishing is capable of producing glass substrates with an average surface roughness greater than about 0.5 nm (Ra), as measured by atomic force microscopy. Glass articles, e.g., glass sheets, produced by the fusion process can possess an average surface roughness as measured by atomic force microscopy of equal to or less than about 0.5 nm, for example equal to or less than about 0.25 nm. Of course, the claims appended herewith should not be limited to fusion processes, as embodiments described herein can be applicable to other forming processes such as, but not limited to, slot draw, float, rolling, and other sheet-forming processes known to those skilled in the art.

Relative to the foregoing alternative methods for creating sheets of glass, the fusion process is capable of creating very thin, very flat, very uniform sheets with a pristine surface. Slot draw also can result in a pristine surface, but due to change in orifice shape over time, accumulation of volatile debris at the orifice-glass interface, and the challenge of creating an orifice to deliver truly flat glass, the dimensional uniformity and surface quality of slot-drawn glass are generally inferior to fusion-drawn glass. The float process is capable of delivering very large, uniform sheets, but the surface is substantially compromised by contact with the float bath on one side, and by exposure to condensation products from the float bath on the other side. This means float glass must be polished before use in high performance display applications.

In spite of the foregoing advantages to fusion forming of glass articles, new applications for glass sheet continue to push the limits of current manufacturing technology. For example, a drive to increase the resolution of visual display devices demands tightened specifications on the glass substrates upon which the electronic components that control the display are deposited, e.g., thin film transistors (TFTs). Typically, these TFT components are deposited by photolithography, and the increased density of TFTs required to produce increased display resolution requires glass that is exceptionally flat in order to accommodate the shallow depth of focus produced by the photo-imaging equipment.

Other technologies may also require exceptional flat glass sheets. For example, demand for ever increasing areal density for HDD platters is pushing the HDD industry to embrace glass. Indeed, glass platters have become commonplace for current HDDs, and particularly for use in laptop computer HDDs, as glass platters hold at least several advantages over aluminum platters. Glass platters can be made with smoother surfaces than is possible with aluminum, thereby accommodating increased areal density and very small fly heights for the read-write head. Glass exhibits greater rigidity for comparable material weight and is stronger for comparable thickness, and therefore glass platters can be made thinner than aluminum platters to accommodate an increase in the number of platters for a given device space. In addition, glass is not susceptible to corrosion like aluminum, and can be used without nickel plating prior to deposition of the magnetic media. The relatively low coefficient of thermal expansion of glass compared to aluminum provides greater thermal stability, reducing track movement and the amount of compensation required from the drive's servo mechanism, and facilitating newer recording techniques, such as heat assisted magnetic recording. Also, the glass surface of the platter is harder than the surface of an aluminum platter, and therefore less susceptible to damage from head crashes.

The manufacture of glass platters for HDDs typically relies on cutting sheets of glass into small coupons (e.g., squares), then cutting an annular disk from the coupon. However, because the read-write head is positioned only several nanometers above the surface of the platter during operation of a disk drive, the platter must be exceptional flat and exhibit a thickness with little to no variation. Accordingly, platters that do not meet these requirements must be ground and/or polished to achieve the necessary flatness. However, grinding and/or polishing adds steps and cost to the manufacturing process. In other manufacturing methods, a gob of molten glass is press-formed between two dies. However, the press forming method is incapable of producing the necessary dimensional requirements and, like the foregoing, the platter blank must be ground and/or polished prior to subsequent processing.

In view of the foregoing, the ability to manufacture flat sheets of glass with minimal thickness variation can provide assurance that product requirements of the future can be met. To do so requires precise temperature control of the glass sheet, which, in a fusion down draw process, is drawn in ribbon form from a forming body positioned in a forming chamber, and through a cooling chamber that includes various temperature control equipment to control shape and thickness, particularly in a lateral (width-wise) direction orthogonal to the draw direction. Such control apparatus and methods have in the past included blowing a coolant, i.e., a gas, such as clean dry air, onto the ribbon or the glass flowing over the forming body as the ribbon is drawn from the forming body. Other methods have included positioning such tubes behind a plate of high thermal conductivity material. Both approaches suffer from splash, which is the outward dispersal of gas from the surface on which the gas is impinged. In the first instance, gas jetted against the molten glass itself is splayed out in all directions on the molten glass, thereby limiting the proximity of one cooling tube to an adjacent cooling tube. Spacing the cooling tubes too closely can result in interference between the splash from one cooling tube and the splash from an adjacent cooling tube. The interference can set up regions of generally uncontrolled cooling between points of impingement of the gas streams. Additionally, the introduction of gas flow into the cooling and/or forming chamber can upset the controlled environment within the chamber(s), thereby causing unintended temperature fluctuations across the width of the ribbon. Such temperature fluctuations can lead to thickness variations, shape changes and residual stress. Thus, using open-ended cooling tubes that exhaust gas directly into the chamber(s) must be spaced apart a sufficient distance that the gas from one cooling tube does not interfere with an adjacent cooling tube, which limits the achievable thickness control. Additionally, because the coolant is impinged directly onto the molten glass, the use of a liquid coolant is not feasible. Because the heat capacity of gases is generally much less than a liquid, the cooling ability of such direct gas impingement systems is hindered. Finally, the side-by-side arrangement of the cooling tubes extending into the forming and/or cooling chambers through a wall thereof requires the sealing of many separate portals into the chambers and the maintenance of such seals, as leakage between the cooling tubes and the chamber walls can lead to disruption of the environment within the chambers.

In the second instance, positioning the cooling tubes behind a high thermal conductivity plate, direct impingement of coolant onto the molten glass can be avoided. However, such systems may still be subject to splash, wherein the splash produced by one cooling tube on the high thermal conductivity plate can still interfere with the splash produced by an adjacent cooling tube, thereby again producing a between-tube region of less-controlled temperature on the high thermal conductivity plate. As in the case above, close spacing of the cooling tubes is therefore restricted. Additionally, even if the cooling tubes are contained within a vessel or container with a ribbon-facing high thermal conductivity plate, there is a risk of gas leakage from the container into the chamber.

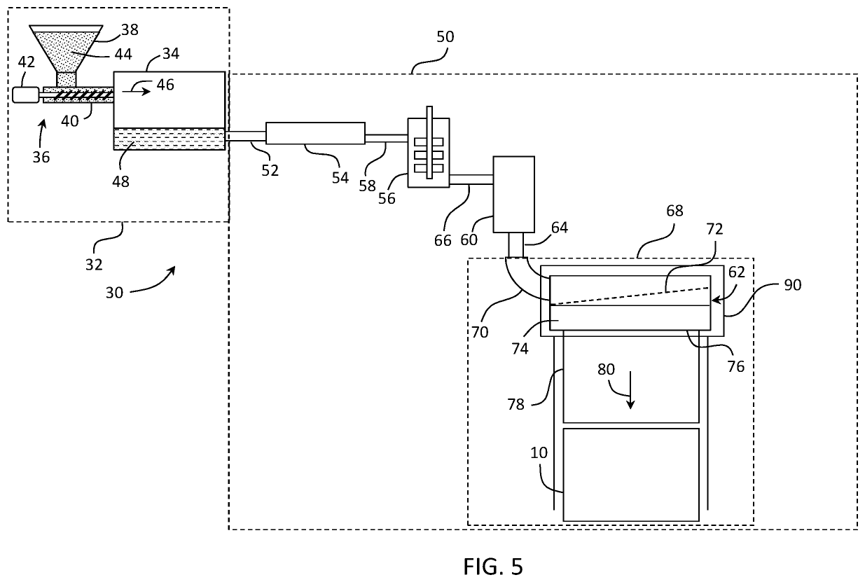

Shown in FIG. 5 is an exemplary fusion down draw glass manufacturing apparatus 30 according to embodiments of the present disclosure. In some embodiments, the glass manufacturing apparatus 30 can comprise a glass melting furnace 32 that can include a melting vessel 34. In addition to melting vessel 34, glass melting furnace 32 can optionally include one or more additional components such as heating elements (e.g., combustion burners and/or electrodes) configured to heat raw material and convert the raw material into molten glass. For example, melting vessel 34 may be an electrically boosted melting vessel, wherein energy is added to the raw material through both combustion burners and by direct heating, wherein an electric current is passed through the raw material, and thereby adding energy via Joule heating of the raw material.

In further embodiments, glass melting furnace 32 may include thermal management devices (e.g., insulation components) that reduce heat loss from the melting vessel. In still further embodiments, glass melting furnace 32 may include electronic devices and/or electromechanical devices that facilitate melting of the raw material into a glass melt. Still further, glass melting furnace 32 may include support structures (e.g., support chassis, support member, etc.) or other components.

Glass melting vessel 34 is typically formed from a refractory material, such as a refractory ceramic material, for example a refractory ceramic material comprising alumina or zirconia, although the refractory ceramic material may comprise other refractory materials, such as yttrium (e.g., yttria, yttria stabilized zirconia, yttrium phosphate), zircon (ZrSiO4) or alumina-zirconia-silica or even chrome oxide, used either alternatively or in any combination. In some examples, glass melting vessel 34 may be constructed from refractory ceramic bricks.

In some embodiments, melting furnace 32 may be incorporated as a component of a glass manufacturing apparatus configured to fabricate a glass article, for example a glass ribbon of an indeterminate length, although in further embodiments, the glass manufacturing apparatus may be configured to form other glass articles without limitation, such as glass rods, glass tubes, glass envelopes (for example, glass envelopes for lighting devices, e.g., light bulbs) and glass lenses, although many other glass articles are contemplated. In some examples, the melting furnace may be incorporated as a component of a glass manufacturing apparatus comprising a slot draw apparatus, a float bath apparatus, a down draw apparatus (e.g., a fusion down draw apparatus), an up draw apparatus, a pressing apparatus, a rolling apparatus, a tube drawing apparatus or any other glass manufacturing apparatus that would benefit from the present disclosure. By way of example, FIG. 1 schematically illustrates glass melting furnace 32 as a component of a fusion down draw glass manufacturing apparatus 30 for fusion drawing a glass ribbon for subsequent processing into individual glass sheets or rolling the glass ribbon onto a spool.

Glass manufacturing apparatus 30 (e.g., fusion down draw apparatus 30) can optionally include an upstream glass manufacturing apparatus 36 positioned upstream relative to glass melting vessel 34. In some examples, a portion of, or the entire upstream glass manufacturing apparatus 36, may be incorporated as part of the glass melting furnace 32.

As shown in the embodiment illustrated in FIG. 1, the upstream glass manufacturing apparatus 36 can include a raw material storage bin 38, a raw material delivery device 40 and a motor 42 connected to the raw material delivery device. Storage bin 38 may be configured to store a quantity of raw material 44 that can be fed into melting vessel 34 of glass melting furnace 32 through one or more feed ports, as indicated by arrow 46. Raw material 44 typically comprises one or more glass forming metal oxides and one or more modifying agents. In some examples, raw material delivery device 40 can be powered by motor 42 such that raw material delivery device 40 delivers a predetermined amount of raw material 44 from the storage bin 38 to melting vessel 34. In further examples, motor 42 can power raw material delivery device 40 to introduce raw material 44 at a controlled rate based on a level of molten glass sensed downstream from melting vessel 34 relative to a flow direction of the molten glass. Raw material 44 within melting vessel 34 can thereafter be heated to form molten glass 48. Typically, in an initial melting step, raw material is added to the melting vessel as particulate, for example as comprising various “sands”. Raw material may also include scrap glass (i.e. cullet) from previous melting and/or forming operations. Combustion burners are typically used to begin the melting process. In an electrically boosted melting process, once the electrical resistance of the raw material is sufficiently reduced (e.g., when the raw materials begin liquefying), electric boost is begun by developing an electric potential between electrodes positioned in contact with the raw materials, thereby establishing an electric current through the raw material, the raw material typically entering, or in, a molten state at this time.

Glass manufacturing apparatus 30 can also optionally include a downstream glass manufacturing apparatus 50 positioned downstream of glass melting furnace 32 relative to a flow direction of the molten glass 48. In some examples, a portion of downstream glass manufacturing apparatus 50 may be incorporated as part of glass melting furnace 32. However, in some instances, first connecting conduit 52 discussed below, or other portions of the downstream glass manufacturing apparatus 50, may be incorporated as part of the glass melting furnace 32. Elements of the downstream glass manufacturing apparatus, including first connecting conduit 52, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 70% to about 90% by weight platinum and about 10% to about 30% by weight rhodium. However, other suitable metals can include molybdenum, rhenium, tantalum, titanium, tungsten and alloys thereof.

Downstream glass manufacturing apparatus 50 can include a first conditioning (i.e. processing) vessel, such as fining vessel 54, located downstream from melting vessel 34 and coupled to melting vessel 34 by way of the above-referenced first connecting conduit 52. In some examples, molten glass 48 may be gravity fed from melting vessel 34 to fining vessel 54 by way of first connecting conduit 52. For instance, gravity may drive molten glass 48 through an interior pathway of first connecting conduit 52 from melting vessel 34 to fining vessel 54. It should be understood, however, that other conditioning vessels may be positioned downstream of melting vessel 34, for example between melting vessel 34 and fining vessel 54. In some embodiments, a conditioning vessel may be employed between the melting vessel and the fining vessel wherein molten glass from a primary melting vessel is further heated in a secondary vessel to continue the melting process, or cooled to a temperature lower than the temperature of the molten glass in the primary melting vessel before entering the fining vessel.

Within fining vessel 54, bubbles may be removed from molten glass 48 by various techniques. For example, raw material 44 may include multivalent compounds (i.e. fining agents) such as tin oxide that, when heated, undergo a chemical reduction reaction and release oxygen. Other suitable fining agents include without limitation arsenic, antimony, iron and cerium, although as noted previously, the use of arsenic and antimony may be discouraged for environmental reasons in some applications. Fining vessel 54 is heated to a temperature greater than the melting vessel temperature, thereby heating the fining agent. Oxygen bubbles produced by the temperature-induced chemical reduction of one or more fining agents included in the melt rise through the molten glass within the fining vessel, wherein gases in the molten glass produced in the melting vessel can coalesce or diffuse into the oxygen bubbles produced by the fining agent. The enlarged gas bubbles with increased buoyancy can then rise to a free surface of the molten glass within the fining vessel and thereafter be vented out of the fining vessel. The oxygen bubbles can further induce mechanical mixing of the molten glass in the fining vessel as they rise through the molten glass.

The downstream glass manufacturing apparatus 50 can further include another conditioning vessel, such as a mixing apparatus 56 for mixing the molten glass that flows downstream from fining vessel 54. Mixing apparatus 56 can be used to provide a homogenous glass melt composition, thereby reducing chemical or thermal inhomogeneities that may otherwise exist within the fined molten glass exiting the fining vessel. As shown, fining vessel 54 may be coupled to mixing apparatus 56 by way of a second connecting conduit 58. In some embodiments, molten glass 48 may be gravity fed from the fining vessel 54 to mixing apparatus 56 by way of second connecting conduit 58. For instance, gravity may drive molten glass 48 through an interior pathway of second connecting conduit 58 from fining vessel 54 to mixing apparatus 56. It should be noted that while mixing apparatus 56 is shown downstream of fining vessel 54 relative to a flow direction of the molten glass, mixing apparatus 56 may be positioned upstream from fining vessel 54 in other embodiments. In some embodiments, downstream glass manufacturing apparatus 50 may include multiple mixing apparatus, for example a mixing apparatus upstream from fining vessel 54 and a mixing apparatus downstream from fining vessel 54. These multiple mixing apparatus may be of the same design, or they may be of a different design from one another. In some embodiments, one or more of the vessels and/or conduits may include static mixing vanes positioned therein to promote mixing and subsequent homogenization of the molten material.

Downstream glass manufacturing apparatus 50 can further include another conditioning vessel such as delivery vessel 60 that may be located downstream from mixing apparatus 56. Delivery vessel 60 may condition molten glass 48 to be fed into a downstream forming device. For instance, delivery vessel 60 can act as an accumulator and/or flow controller to adjust and provide a consistent flow of molten glass 48 to forming body 62 by way of exit conduit 64. As shown, mixing apparatus 56 may be coupled to delivery vessel 60 by way of third connecting conduit 66. In some examples, molten glass 48 may be gravity fed from mixing apparatus 56 to delivery vessel 60 by way of third connecting conduit 66. For instance, gravity may drive molten glass 48 through an interior pathway of third connecting conduit 66 from mixing apparatus 56 to delivery vessel 60.

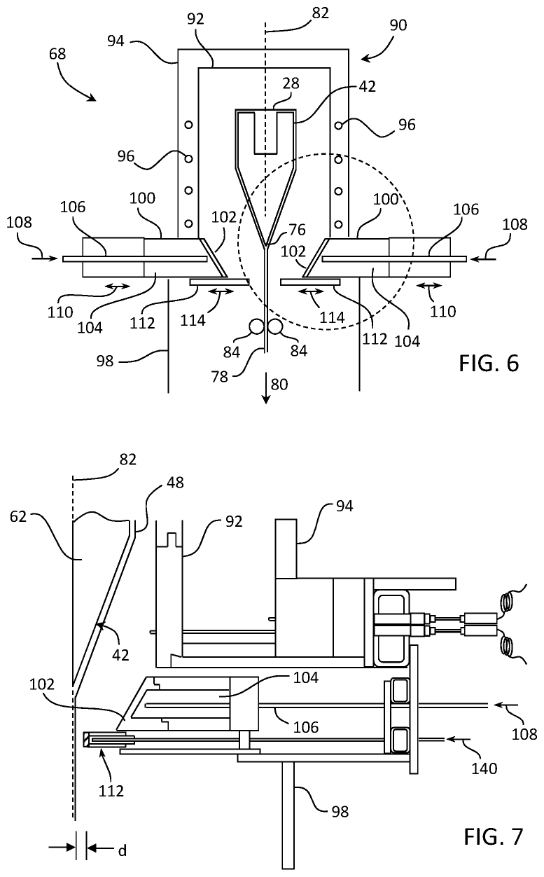

Downstream glass manufacturing apparatus 50 can further include forming apparatus 68 comprising the above-referenced forming body 62, including inlet conduit 70. Exit conduit 64 can be positioned to deliver molten glass 48 from delivery vessel 60 to inlet conduit 70 of forming apparatus 68. Forming body 62 in a fusion down draw glass making apparatus can comprise a trough 72 positioned in an upper surface of the forming body and converging forming surfaces 74 (only one surface shown) that converge in a draw direction along a bottom edge (root) 76 of the forming body. Molten glass delivered to the forming body trough via delivery vessel 60, exit conduit 64 and inlet conduit 70 overflows the walls of the trough and descends along the converging forming surfaces 74 as separate flows of molten glass. The separate flows of molten glass join below and along the root to produce a single glass ribbon 78 of molten glass that is drawn in a draw direction 80 from root 76 along a draw plane 82 (see FIG. 6) by applying tension to the glass ribbon, such as by gravity and various rolls, e.g., pulling rolls 84 (see FIG. 6), to control the dimensions of the glass ribbon as the molten glass cools and a viscosity of the material increases. Accordingly, glass ribbon 78 goes through a visco-elastic transition and acquires mechanical properties that give glass ribbon 78 stable dimensional characteristics. Glass ribbon 78 may in some embodiments be separated into individual glass sheets 10 by a glass separation apparatus (not shown) in an elastic region of the glass ribbon, although in further embodiments, the glass ribbon may be wound onto spools and stored for further processing. Additionally, thickened edge portions, termed beads, may be removed, either on-line, from glass ribbon 78, or from individual glass sheets 10 after separation from glass ribbon 78.

Because glass ribbon 78, and subsequent glass sheets 10, are formed by the fusing of two separate flows of molten glass, glass sheet 10 comprises an interface between the separate layers visible from an edge of the glass sheet. The interface is visible as a line (fusion line) 18 along an edge of the glass sheet. Moreover, the two layers of the glass sheet, owing to their single source of molten glass, have the same chemical composition. However, in other embodiments, not illustrated, multiple forming bodies may be used, wherein molten glass flowing from a first forming body flows onto the molten glass in the trough of a second forming body positioned below the first forming body such that the ribbon drawn from the second forming body comprises more than two layers. That is, the molten glass provided to the first forming body need not be the same chemical composition as the molten glass flowing to the second forming body. Accordingly, a glass sheet comprising more than two layers of glass, and more than one fusion line (more than one interface), can be produced.

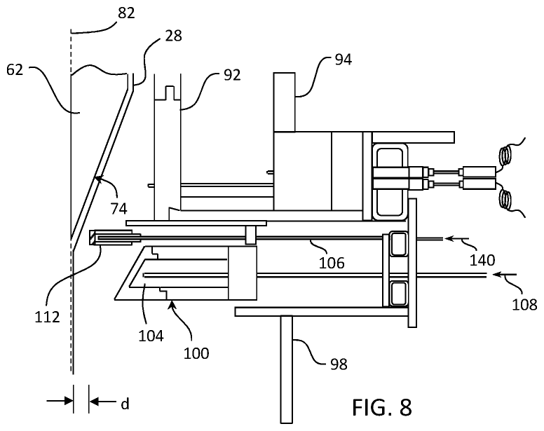

Referring now to FIGS. 6-8, forming body 62 is positioned within a forming chamber 90 to maintain a controlled environment around forming body 62 and the glass ribbon drawn therefrom. For example, as shown in FIGS. 7 and 8, forming chamber 90 may can comprise a first, inner forming chamber 92. Inner forming chamber 92 is further contained within and spaced apart from an outer forming chamber 94. Heating elements 96 can be positioned in the space between the inner and outer forming chambers and are used to control a temperature, and therefore a viscosity, of molten glass 48, such that the molten glass is at a suitable viscosity for forming. A lower cooling chamber 98 forms a channel about glass ribbon 78 as the glass ribbon is drawn from root 76 and aids in establishing a controlled environment for the glass ribbon as it transitions from a viscous liquid to an elastic solid with set dimensions. Accordingly forming apparatus 68 may further comprise cooling devices 100, for example configured as a pair of cooling doors 100 extending in a width-wise direction of the ribbon, parallel to draw plane 82. Cooling doors 100 comprise a ribbon-facing panel 102, also extending in a width-wise direction of the ribbon, parallel to draw plane 82. Ribbon-facing panel 102 may be formed from a high thermal conductivity material capable of withstanding the high temperatures within inner chamber 92, such as equal to or greater than 1100° C. A suitable exemplary material is silicon carbide (SiC). Cooling doors 100 comprise a cavity 104 into which a plurality of cooling tubes 106 are positioned, the cooling tubes 106 in fluid communication with a source (not shown) of cooling gas. Cooling tubes 106 include an open end positioned adjacent to and spaced apart from an inside surface of ribbon-facing panel 102. A cooling gas 108 is directed to the cooling tubes and flowed from the cooling tubes against the inside surface of the ribbon-facing panels, thereby cooling the ribbon-facing panels. The cooled ribbon-facing panels 102 form a heat sink adjacent glass ribbon 78 and help to cool the ribbon. The flow of cooling gas 105 to each cooling tube 106 may be individually controlled, so that control of the ribbon temperature can be conducted locally. As illustrated in FIGS. 6 and 7, ribbon-facing panels 102 are typically angled so that the end faces are approximately parallel to the converging forming surfaces 74, thereby maximizing the effect of the cooling door on the glass flowing over the converging forming surfaces. As indicated by arrows 110, cooling doors 100 are movable in a direction orthogonal to draw plane 82. However, it should be noted that the ability of the cooling doors to move into close proximity of the flows of molten glass is limited, as the angled orientation of the end faces increases the likelihood of molten glass that may drip from the forming body to contact and coat the outside surfaces of the ribbon-facing panels 102, decreasing the thermal conductivity of the ribbon-facing panels and thereby interfering with temperature and viscosity control of glass ribbon 78. Thus, cooling doors 100 are typically positioned outside a direct vertical range of the forming surfaces.

Forming apparatus 68 further comprises slide gates 112, positioned on opposite sides of glass ribbon 78. In some embodiments, for example the embodiment of FIGS. 6 and 7, slide gates 112 are positioned below cooling doors 100. However, in other embodiments, as shown in FIG. 8, slide gates 112 can be positioned above cooling doors 100. In still other embodiments, slide gates may be positioned both above and below the cooling doors. As indicated by arrows 114, slide gates 112 are movable in a direction orthogonal to draw plane 82.

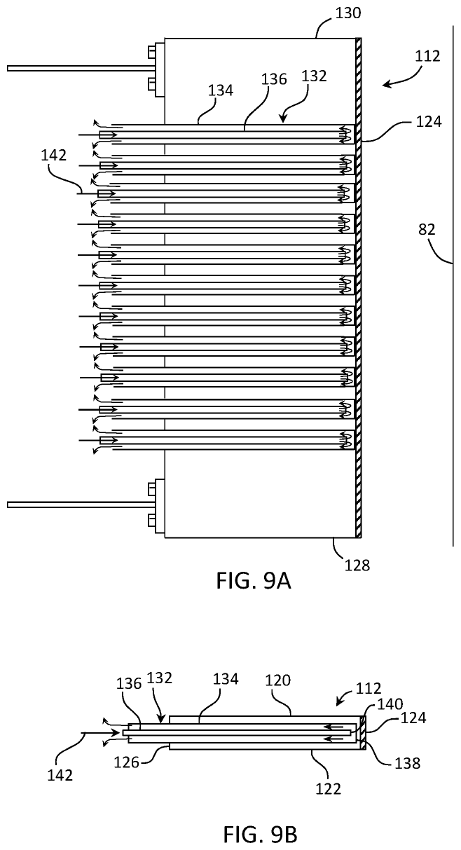

FIGS. 9A and 9B illustrate a cross sectional top view and side view, respectively, of an exemplary slide gate 112. Slide gate 112 comprises a top wall 120, a bottom wall 122 and a ribbon-facing panel (thermal plate) 124. Slide gate 112 is positioned such that thermal plate 124 is adjacent to glass ribbon 78. A distance between thermal plate 124 and an adjacent major surface of glass ribbon78 is defined as “d”. Thermal plate 124 is formed from a high thermal conductivity material, such as SiC. Thermal plate 124 may be angled, for example at an angle approximating the angle of the converging forming surfaces 74, or thermal plate 124 may be vertical and substantially parallel to draw plane 82. Slide gate 112 may further comprise a back wall 126 connecting top wall 120 and bottom wall 122, and end walls 128, 130.

Slide gate 112 further comprises a plurality of cooling tubes 132 positioned within the slide gate. Each cooling tube 132 of the plurality of cooling tubes comprises an outer tube 134 and an inner tube 136. Outer tube 134 and inner tube 136 may, in some embodiments, comprise a circular shape in a cross section orthogonal to a longitudinal axis of the cooling tube, although in further embodiments, either one or both of the outer tube and the inner tube may have other cross sectional shapes, such as rectangular shapes, oval shapes, or any other suitable geometric shape. In some embodiments, inner tube 136 may be concentric with outer tube 134 about a central longitudinal axis of the cooling tube. Each outer tube 134 of the plurality of outer tubes comprises a closed distal end 138 positioned proximate an inside surface of thermal plate 124. In some embodiments, distal end 138 is in contact with thermal plate 124. Each inner tube 136 of the plurality of inner tubes includes an open distal end 140 proximate the closed distal end 138 of outer tube 134. A cooling fluid 142 supplied to inside tube 136 is exhausted through open distal end 140 and impinges on the closed distal end 138 of outer tube 134. The cooling fluid expelled from open distal end 140 then flows back through a space between outer tube 134 and inner tube 136, whereupon the cooling fluid may be vented from cooling tube, or chilled, such as in a heat exchanger (not shown) and recycled back to the cooling tube. Cooling fluid 142 can be a gas, such as an inert gas, or even air, or a liquid, for example water.

Unlike cooling devices that exhaust a cooling gas directly onto the ribbon, the internal streams of cooling fluid circulated through cooling tubes 132 do not interact with the cooling fluid of an adjacent cooling tube, thus, cooling tubes 132 can be spaced as closely together as the size of the cooling tubes permit. Moreover, the flow rate of cooling fluid through the cooling tubes can be increased to as high as necessary and possible. Additionally, by containing the cooling fluid entirely within the cooling tubes while within the slide gate, a flow of cooling fluid is prevented from entering the cooling chamber 98 containing the ribbon. By comparison, the cooling gas entering cooling doors 100 from cooling tubes 106 can leak into the cooling chamber and disrupt the thermal environment within the cooling chamber, thereby causing uncontrolled temperature variations across a width or down a length of ribbon 78 that can lead to the formation of residual stress in the ribbon as the ribbon cools. In some embodiments, cooling fluid 142 used within cooling tubes 132 can be a liquid, for example water, without danger of injecting water into the cooling chamber. The use of a liquid, with a higher heat capacity than a gas, can increase the cooling ability of the cooling tubes.

In some embodiments, slide gate 112 may comprise a solid plate formed of a metal resistant to high temperature, wherein passages have been formed, such as by drilling, in the metal plate. Each passage serves as an outer tube 134, the walls of each passage defining the inside diameter of the “tube”. Into each passage an inner tube 136 may be positioned, wherein the cooling fluid is injected into the passage in the manner described above. In some embodiments, a center longitudinal axis of each passage (e.g., outer tube) can be spaced apart from the longitudinal axis of an adjacent passage by a distance in a range from about 1 cm to about 1.5 cm.

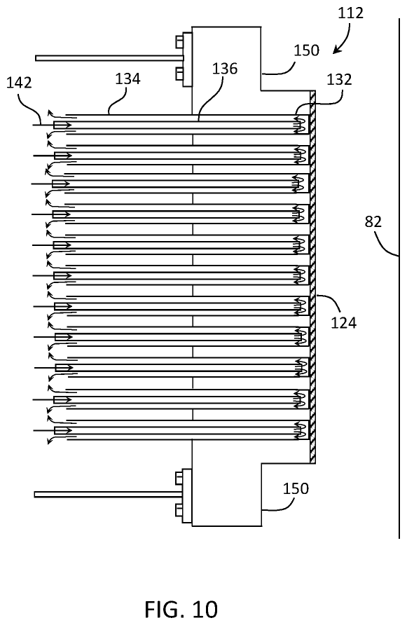

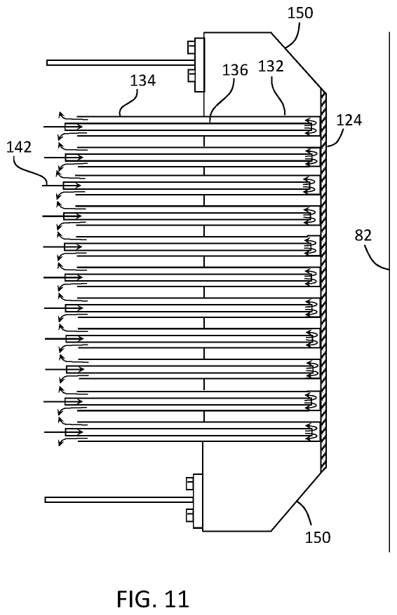

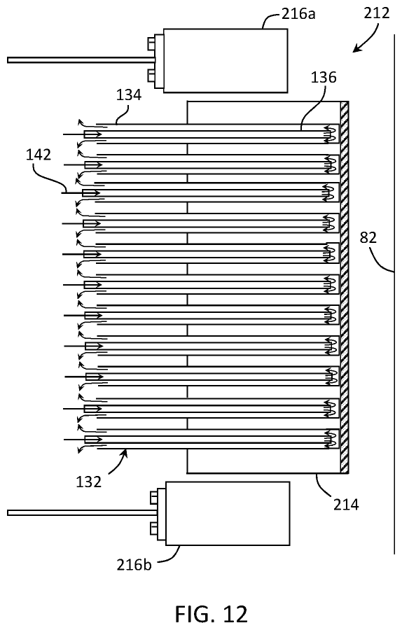

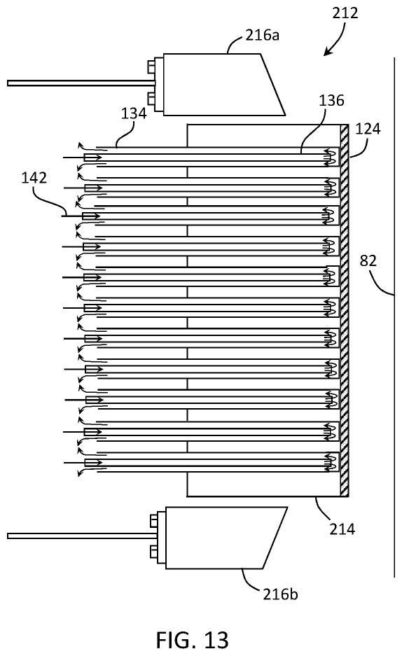

Slide gates 112 may have a variety of shapes. For example, another exemplary slide gate 112 is illustrated in FIG. 10. In the embodiment of FIG. 10, end portions 150 of the slide gate are recessed relative to draw plane 82. In the embodiment of FIG. 11, end portions 150 of slide gate 112 are angled relative to draw plane 82 such that forward edges of the slide gate at the ends of the slide gate slope backward in a direction away from draw plane 82. In still other embodiments, the slide gate may comprise a plurality of separate components. For example in the embodiment of FIG. 12, an exemplary slide gate 212 comprises a central portion 214 comprising cooling tubes 132, and end portions 216a, 216b positioned adjacent ends of central portion 214. End portions 216a, 216b may have forward edges parallel with draw plane 82, or, as depicted in FIG. 13, end portions 216a, 216b may have angled forward edges that slope backward in a direction away from draw plane 82. End portions 216a, 216b may be individually and separately movable, such that the end portions and the central portion may be positioned at different distances from glass ribbon 78.

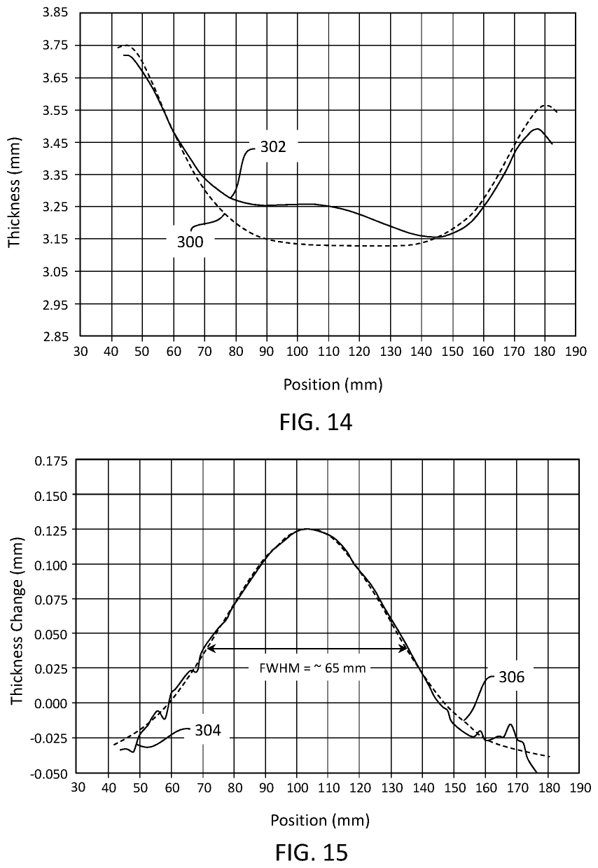

FIG. 14 are plots of measured data showing the effect of a single cooling tube located at a position 105 mm from a lateral edge of glass ribbon 78 on the thickness of a 3.3 mm thick ribbon of molten glass. The ribbon was approximately 22 cm in width. The diameter of the outer tube was approximately 1.3 cm. The inside tube was approximately 1 cm in diameter. The internal airflow of the cooling tube was 40 standard cubic feet per hour. The tube was positioned approximately 1.3 cm from the surface of the ribbon. Curve 300 represents the thickness in the absence of the cooling tube, whereas curve 302 represents the thickness in the presence of the cooling tube. The curves show a significant change in the thickness in the vicinity of the cooling tube. FIG. 15 is a plot depicting the difference between the curves of FIG. 14, wherein curve 304 represents the difference, and curve 306 represents a Gaussian fit to curve 304. The resultant thickness change is shown to be approximately 150 micrometers, or about 3.3% of the nominal 3.3 mm thickness. Additionally, a full width half maximum (FWHM) value of the Gaussian curve 306 is approximately 65 mm.

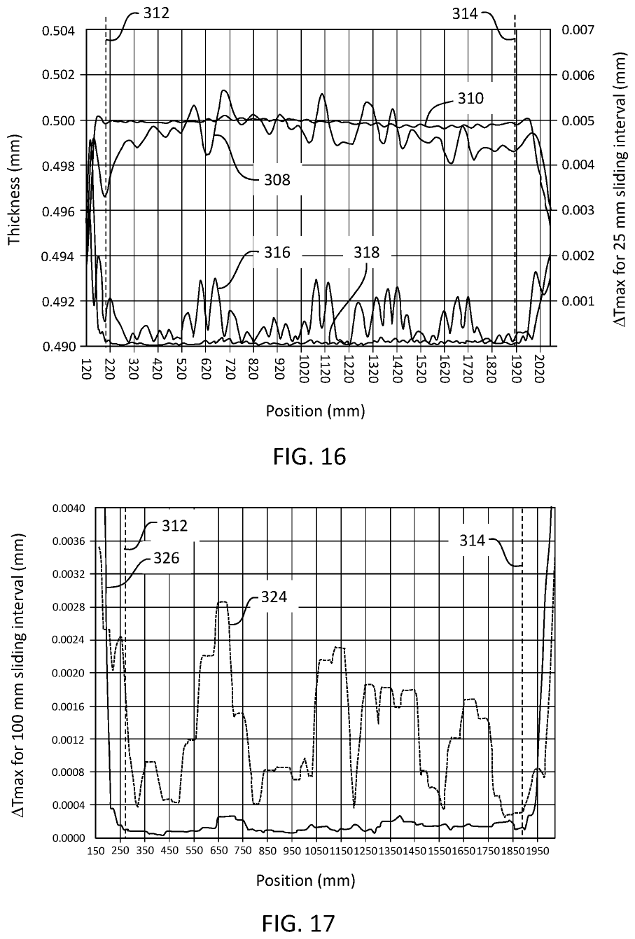

FIG. 16 is a plot showing how thickness uniformity can be improved for a fusion drawn glass ribbon. Curve 308 is represents actual thickness data for a conventional fusion process. The date is plotted relative to the distance from a lateral edge of the ribbon. Curve 310 represents modeled data after implementation of a pair of slide gates 112 positioned above the cooling doors as a function of position across a width of glass ribbon 78. Lines 312 and 314 represent the edges of the beads, wherein the portion of the ribbon between the bead portions is the commercially valuable “quality region” of the ribbon. The data show that after implementation of the actively cooled slide gates, thickness variability within the quality region dropped from a TTV of about 0.0018 mm without actively cooled slide gates to about 0.0007 mm with slide gates. Additionally, curve 316 represents ΔTmax for a sliding interval of 25 mm moved in 5 mm increments across a width of the ribbon, and curve 318 represents ΔTmax for a sliding interval of 25 mm moved in 5 mm increments across a width of the modeled ribbon in the presence of the actively cooled slide gate. As indicated, MSIR in the quality region for the actual ribbon without the slide gates yields an MSIR of about 0.0015 mm, whereas the MSIR for the modeled ribbon in the presence of actively cooled slide gates above the cooling doors is about 0.0005 mm.

FIG. 17 is a plot slowing ΔTmax using a 100 mm sliding interval moved across a width of a glass ribbon in 5 mm increments and plotted as a function of position from a lateral edge of the ribbon. Lines 320 and 322 denote the boundaries of the quality region. Curve 324 represents ΔTmax for actual data measured on the ribbon, without slide gates, and curve 326 represents modeled data, with actively cooled slide gates. The data show an MSIR of about 0.00285 mm without slide gates, and an MSIR of about 0.00025 mm with actively cooled slide gates.

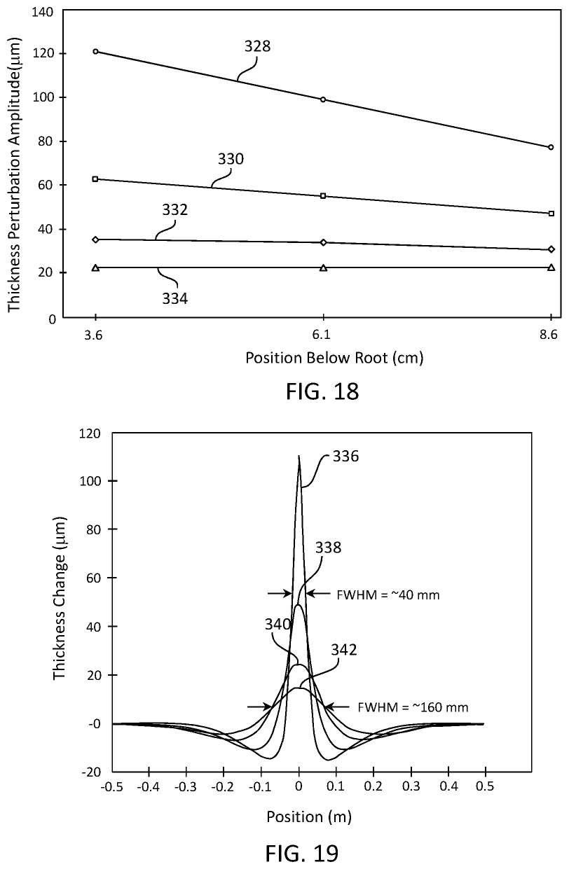

FIG. 18 shows the results of a study using a modeled 1.3 cm square “cold spot” positioned parallel to the flowing glass ribbon at various distances from and normal to the draw plane and at varying distances below root 76 (plotted across the horizontal axis). The cold spot can be, for example the end of a closed cooling tube 132, in this instance a cooling tube with a square cross section. The vertical axis displays an amplitude of the thickness change. In FIG. 18, curve 328 represents a distance between the cold spot (e.g., the end of the cooling tube) and the ribbon of 1.3 cm, curve 330 represents a distance d between the cold spot and the ribbon of 3.8 cm, curve 332 represents a distance between the cold spot and the ribbon of 6.4 cm, and curve 334 represents a distance between the cold spot and the ribbon of 8.9 cm. The data show that being closer to the root line with minimal distance between the cold surface and the flowing surfaces of the ribbon gives the maximum thickness impact.

FIG. 19 illustrates thickness change as a function of position relative to a centerline of the ribbon, in meters, for 4 different temperature (viscosity) perturbations at a location 3.6 cm below the root of the forming body and using a modeled 1.3 cm square “cold spot” positioned parallel to the flowing glass ribbon normal to the draw plane and at varying distances from the surface of the ribbon. When the cold spot is 1.3 cm away from the glass surface (curve 336), the FWHM of the primary thickness perturbation is approximately 40 mm. Curve 338 represents the cold spot at a location 3.8 cm from the ribbon surface, curve 340 represents the cold spot at a location 6.4 cm from the ribbon surface and curve 342 represents the cold spot at a location 8.9 cm from the ribbon surface. When the cold spot is located at 8.9 cm from the glass surface, the FWHM is approximately 160 mm. As shown, generally, the FWHM will be linearly related to the distance of the cold spot to the glass surface.

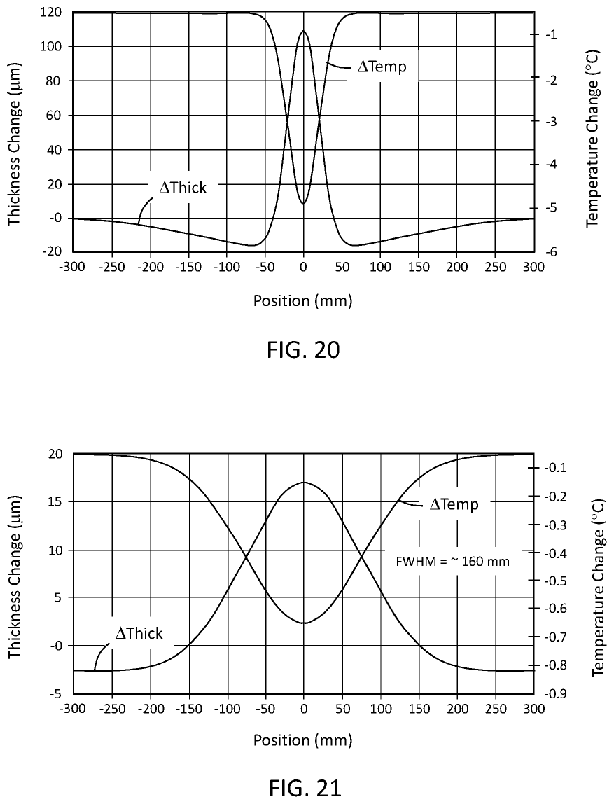

FIGS. 20 and 21 illustrate how the thickness profile changes seen in FIG. 19 (1.3 cm and 8.9 cm cases) are caused by changes in the temperature field at the same location. FIG. 20 represents the 1.3 cm case from FIG. 19 and FIG. 21 represents the 8.9 cm case from FIG. 19. In both figures, the curves ΔThick denote the curve for thickness change, and the curve ΔTemp denoted the curve for temperature change. The horizontal axis indicates distance from the centerline of the ribbon. The data show that the magnitude of the thickness profile change will be linearly related to the magnitude of the temperature change at the surface of the glass, and the FWHM of both will be nearly the same. Due to conservation of mass, the integrated area about the zero line should sum to zero in the case of the thickness profile. Further, the data show the relationship between the temperature change at the surface of the glass is related to the ribbon thickness change.

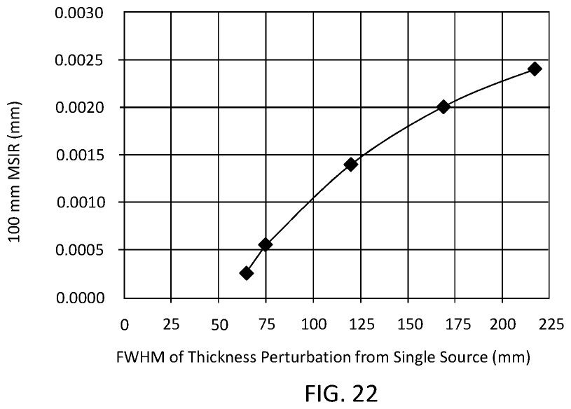

FIG. 22 shows the results of further modeling where the characteristic width (FWHM) of the thickness perturbation induced by a single control point is varied over a range from 65 mm to 220 mm. The data show that the ability to reduce MSIR, in this instance for a 100 mm sliding interval moved across a width of the ribbon in 5 mm increments, is a strong function of the FWHM of the individual control points distributed along the horizontal breadth of the glass ribbon. The plot shows, for example, that to achieve an MSIR of 0.00025, one needs to induce a thickness perturbation with a FWHM of approximately 65 mm. As the FWHM increases, so too does the MSIR. Generally, then, to obtain an MSIR for a 100 mm sliding interval equal to or less than about 0.0024, the interval moved in increments of 5 mm for example, one must induce a thickness perturbation equal to or less than about 215 mm. To obtain an MSIR for a 100 mm sliding interval equal to or less than about 0.0020, the interval moved in increments of 5 mm for example, one induces a thickness perturbation equal to or less than about 165 mm. To obtain an MSIR for a 100 mm sliding interval equal to or less than about 0.0014, the interval moved in increments of 5 mm for example, one induces a thickness perturbation equal to or less than about 120 mm. To obtain an MSIR for a 100 mm sliding interval equal to or less than about 0.00055, the interval moved in increments of 5 mm for example, one induces a thickness perturbation equal to or less than about 60 mm. It should be noted that the manner of inducing the thickness perturbation is independent of the results of FIG. 22.

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

1. A glass article, comprising:
a length equal to or greater than about 880 mm;
a width orthogonal to the length and equal to or greater than about 680 mm;
a first major surface, a second major surface opposing the first major surface, and a thickness T defined between the first and second major surfaces; and
wherein a total thickness variation TTV across the width of the glass article is equal to or less than about 4 μm.

2. The glass article according to claim 1, wherein TTV is equal to or less than about 2 μm.

3. The glass article according to claim 1, wherein TTV is equal to or less than about 1 μm.

4. The glass article according to claim 1, wherein the TTV is equal to or less than about 0.25 μm.

5. The glass article according to claim 1, wherein the first and second major surfaces are unpolished.

6. The glass article according to claim 5, wherein an average surface roughness Ra of the first and second major surfaces is equal to or less than about 0.25 nm.

7. The glass article according to claim 1, wherein a maximum sliding interval range MSIR obtained from a predetermined interval moved in 5 mm increments across a width of the glass article is equal to or less than about 4 μm.

8. The glass article according to claim 7, wherein the predetermined interval is in a range from about 25 mm to about 750 mm.

9. The glass article according to claim 8, wherein the predetermined interval is in a range from about 25 mm to about 100 mm.

10. The glass article according to claim 8, wherein the predetermined interval is in a range from about 25 mm to about 75 mm.

11. The glass article according to claim 1, wherein the width is equal to or greater than about 3100 mm.

12. The glass article according to claim 11, wherein the length is equal to or greater than about 3600 mm.

13. The glass article according to claim 1, wherein the glass is a substantially alkali free glass, comprising in mole percent:

| | |
|---|---|
| SiO₂ | 60-80 |
| Al₂O₃ | 5-20 |
| B₂O₃ | 0-10 |
| MgO | 0-20 |
| CaO | 0-20 |
| SrO | 0-20 |
| BaO | 0-20 |
| ZnO | 0-20 |

14. The glass article according to claim 1, wherein the glass is a substantially alkali free glass, comprising in mole percent:

| | |
|---|---|
| SiO₂ | 64.0-71.0 |
| Al₂O₃: | 9.0-12.0 |
| B₂O₃: | 7.0-12.0 |
| MgO: | 1.0-3.0 |
| CaO: | 6.0-11.5 |
| SrO: | 0-2.0 |
| BaO: | 0-0.1, |

where 1.00≤Σ[RO]/[Al₂O₃]≤1.25, [Al₂O₃] is the mole percent of Al₂O₃ and Σ[RO] equals the sum of the mole percents of MgO, CaO, SrO, and BaO.

15. A glass article, comprising:
a length equal to or greater than about 880 mm;
a width orthogonal to the length and equal to or greater than about 680 mm;
a first major surface, a second major surface opposite the first major surface, and a thickness T defined therebetween; and
wherein a maximum sliding interval range MSIR obtained from a predetermined interval equal to or less than about 750 mm moved in 5 mm increments across a width of the glass article is equal to or less than about 8 μm.

16. The glass article according to claim 15, wherein MSIR is equal to or less than about 6.5 μm for a sliding interval equal to or less than about 400 mm.

17. The glass article according to claim 15, wherein MSIR is equal to or less than about 6 μm for a sliding interval equal to or less than about 330 mm

18. The glass article according to claim 15, wherein MSIR is equal to or less than about 4.5 μm for a sliding interval equal to or less than about 150 mm.

19. The glass article according to claim 15, wherein MSIR is equal to or less than about 4 μm for a sliding interval equal to or less than about 100 mm.

20. The glass article according to claim 15, wherein MSIR is equal to or less than about 2 μm for a sliding interval equal to or less than about 25 mm.

21. The glass article according to claim 15, wherein the first and second major surfaces are unpolished.

22. The glass article according to claim 21, wherein an average surface roughness Ra of the first and second major surfaces is equal to or less than about 0.25 nm.

23. The glass article according to claim 15, wherein the width is equal to or greater than about 3100 mm.

24. The glass article according to claim 23, wherein the length is equal to or greater than about 3600 mm.

25.-50. (canceled)

51. A method of making a glass article, comprising:
flowing molten glass into a trough of a forming body, the molten glass overflowing the trough and descending along opposing forming surfaces of the forming body as separate flows of molten glass that join below a bottom edge of the forming body;
drawing a ribbon of the molten glass from the bottom edge in a draw direction;
cooling the ribbon with a cooling apparatus comprising a thermal plate extending in a width direction of the glass ribbon orthogonal to the draw direction, the cooling apparatus further comprising a plurality of cooling tubes positioned within the cooling apparatus, each cooling tube of the plurality of cooling tubes comprising a first tube with a closed end adjacent the thermal plate and a second tube extending into the first tube with an open end spaced apart from the closed end of the first tube, the cooling comprising flowing a cooling fluid into the second tubes of the plurality of cooling tubes, the cooling further comprising forming a plurality of thickness perturbations on the ribbon corresponding to a location of each cooling tube, each thickness perturbation comprising a characteristic width equal to or less than about 225 mm.

52.-55. (canceled)

56. The method according to claim 51, wherein each cooling tube of the plurality of cooling tubes is in contact with the thermal plate.

57. An apparatus for making a glass ribbon, comprising:
a forming body comprising a trough configured to receive a flow of molten glass and converging forming surfaces that join along a bottom edge of the forming body from which a glass ribbon is drawn in a draw direction along a vertical draw plane;
a cooling apparatus positioned below the bottom edge comprising a thermal plate extending in a width direction of the flow of molten glass and a plurality of cooling tubes positioned within the cooling apparatus, each cooling tube of the plurality of cooling tubes comprising a first tube with a closed end adjacent the thermal plate and a second tube extending into the first tube with an open end adjacent the closed end of the first tube.

58. The apparatus according to claim 57, wherein each first tube of the plurality of cooling tubes is in contact with the thermal plate.

59. The apparatus according to claim 57, wherein a longitudinal axis of each first tube intersects the draw plane a distance from the bottom edge equal to or less than about 8.5 cm.

60. The apparatus according to claim 59, wherein the distance between the intersection and the bottom edge is equal to or less than about 3.6 cm.

61. The apparatus according to claim 59, wherein a distance between the draw plane and the thermal plate is equal to or less than about 9 cm.

62. The apparatus according to claim 61, wherein the distance between the draw plane and the thermal plate is equal to or less than about 1.5 cm.

63.-64. (canceled)
